(19) United States
(12) Patent Application Publication
(10) Pub. No.: US 2015/0302401 A1
(43) Pub. Date: Oct. 22, 2015

(54) DISTRIBUTED CRYPTO CURRENCY UNAUTHORIZED TRANSFER MONITORING SYSTEM

(71) Applicant: EBAY INC., San Jose, CA (US)

(72) Inventor: Max Edward Metral, Brookline, MA (US)

(21) Appl. No.: 14/256,795

(22) Filed: Apr. 18, 2014

(51) Int. Cl. G06Q 20/38; G06Q 20/06; G06Q 20/40

(52) U.S. Cl. CPC G06Q 20/3829; G06Q 20/40; G06Q 20/06

(57) ABSTRACT

Distributed crypto currency systems and methods include receiving a payer public key that is associated with a current transaction between a payer and a payee. It is determined whether the payer public key is included in a plurality of previous transaction public keys that are each associated with a respective unauthorized crypto currency transfer as a result of a previous transaction. In response to determining that the payer public key is included in the plurality of previous transaction public keys, a message is sent to the payee to not proceed with the current transaction. In response to determining that the payer public key is not included in the plurality of previous transaction public keys, a message is sent to the payee to proceed with the current transaction.

### BACKGROUND

1. Field of the Invention

The present invention generally relates to online and/or mobile payments and more particularly to a system for monitoring unauthorized transfers in a distributed crypto currency system that may be used to make online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Conventional payment service providers typically provide for payment by a payer to a payee through the use of payer accounts of the payer (e.g., credit accounts, banking account, and/or a variety of other payer accounts that may be provided by an account provider.). For example, the payment service provider may provide a payment service account to the payer, and the payer may link one or more payer accounts to the payment service account (or the payment service account may include a payer account provided by the payment service provider). In a transaction between the payer and the payee, the payment service provider may then transfer funds from one of the payer accounts to a payee account of the payee (which may also be provided by the account providers or payment service provider). The use of such payer accounts, payee accounts, and payment service accounts is controlled by one or more account providers that operate to ensure that funds in the payer accounts or payee accounts are not misappropriated, and to mediate disputes associated with the transfer of funds between payer accounts and payee accounts.

An alternative to payer accounts and payee accounts provided by account providers is the use of distributed crypto currencies such as, for example, Bitcoin, Ripple, Litecoin, Aurora Coin, Peercoin, and/or a variety of other distributed crypto currencies known in the art. Distributed crypto currencies are not controlled by any central authority, but rather by a distributed network of computing devices that operate to confirm transfers of the crypto currency between payers and payees. Such decentralized distributed crypto currencies provide for the non-reversible transfer of the crypto currency between users in the system, as there is no central authority that ensures that funds of the users are not misappropriated or that mediates disputes associated with the transfer of the crypto currency between users. In other words, once a transfer has been made from a payer to a payee, there is no way to reverse that transfer unless the payee decides to transfer the crypto currency back to the payer in a new transaction. This feature of distributed crypto currencies provides a number of benefits (e.g., reduced transaction costs), but opens the system up to theft by any user that can access the crypto currency of another user such that that crypto currency may be transferred.

Thus, there is a need for an improved distributed crypto currency system.

### BRIEF DESCRIPTION OF THE FIGURES

FIG. 1 is a flow chart illustrating an embodiment of a method for providing a distributed crypto currency system;

FIG. 2 is a schematic view illustrating an embodiment of an electronic coin;

FIG. 3 is a schematic view illustrating an embodiment of a crypto currency public ledger;

FIG. 4 is a schematic view illustrating an embodiment of a distributed crypto currency system;

FIG. 5 is a schematic view illustrating an embodiment of a plurality of previous transaction public keys that are associated with unauthorized crypto currency transfers;

FIG. 6 is a schematic view illustrating an embodiment of a networked system;

FIG. 7 is a perspective view illustrating an embodiment of a payer/payee/user device;

FIG. 8 is a schematic view illustrating an embodiment of a computer system; and

FIG. 9 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure describe systems and methods for providing a distributed crypto currency unauthorized transaction monitoring system that introduces disincentives for stealing or otherwise transferring that crypto currency with the authorization of its owner. In embodiments discussed below, a system provider or providers operate to provide for the reporting of unauthorized crypto currency transfers, record public keys that are used in the unauthorized transfer of crypto currencies from their owner, and store any of those public keys in a database. Those public keys may then become blacklisted such that when a current transaction between a payer and a payee is performed, the payer public key that is associated with the current transaction ay be sent to the system provider and if the system provider determines that the payer public key is blacklisted (i.e., explicitly stored in the database or associated with a public key that is stored in the database), the current transaction may be stopped and/or the payee may be informed not to proceed with the current transaction. Thus, payers that attempt to spend crypto currencies that they have obtained through unauthorized transfer from a previous owner will be unable to do so with payees participating in the system, reducing the value of any crypto currency obtained through unauthorized transfer.

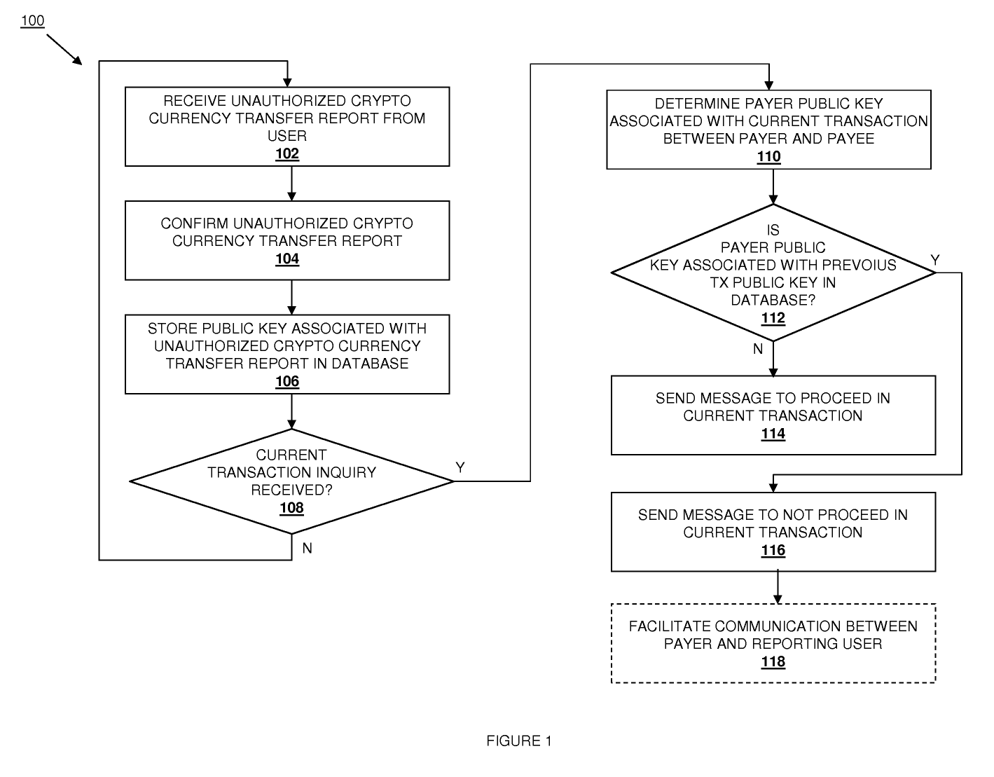

Referring now to FIGS. 1, 2, and 3, a method 100 for providing a distributed crypto currency is illustrated. In some embodiments of the method 100 described below, one or more system provider devices may operate to perform the method 100. For example, a distributed group of devices may operate to create (a.k.a. “mine”) the distributed crypto currency, monitor transactions performed using the crypto currency (e.g., an action that may be performed during the creation of the distributed crypto currency via a crypto currency public ledger), and perform the method 100 as detailed below. In another embodiment, one or more system provider devices may perform the method 100 separate from the creation/monitoring of the distributed crypto currency. For example, a payment service provider such as, for example, PayPal, Inc. of San Jose, Calif., may utilize a payment service provider device to perform the method 100 discussed below, and in some embodiments may operate in cooperation with one or more other system providers (via their system provider devices) and/or payees (via their payee devices) to perform the method 100 discussed below. However, these embodiments are meant to be merely exemplary, and one of skill in the art in possession of the present disclosure will recognize that a wide variety of system providers may operate, alone or together, to provide the systems and methods discussed herein without departing from the scope of the present disclosure.

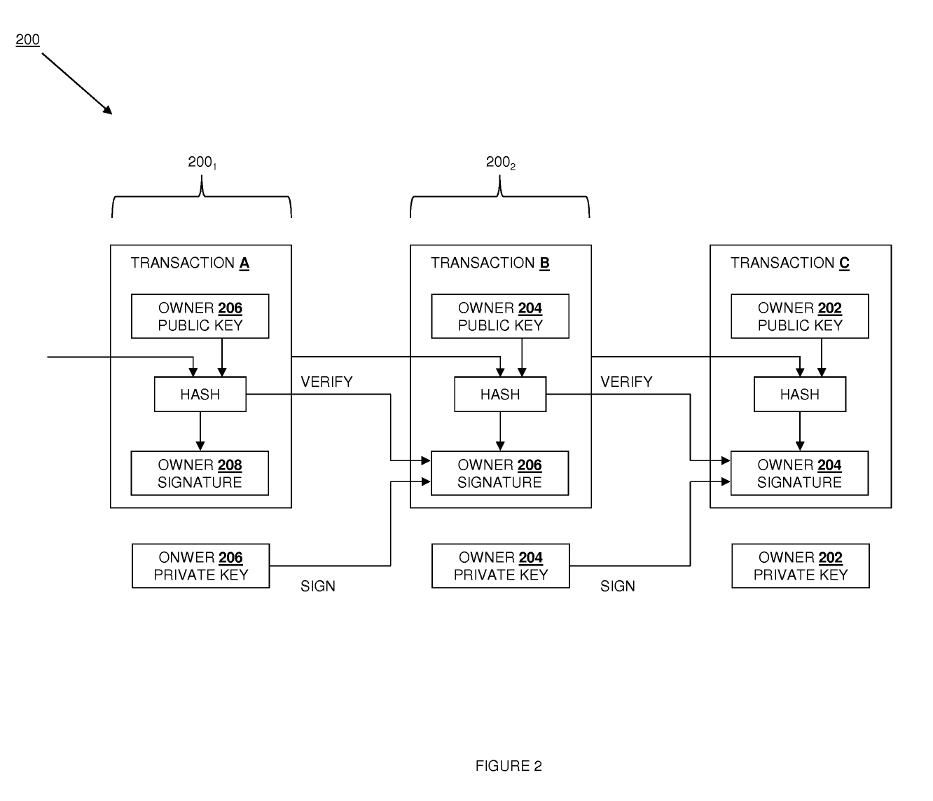

Referring now to FIG. 2, an embodiment of an electronic coin 200 is illustrated and described briefly for reference to the method 100 discussed below. The crypto currency system associated with the present disclosure defines an electronic coin as a chain of digital signatures provided by previous owners of the electronic coin to subsequent owners of the electronic coin. In the illustrated embodiment, the electronic coin 200 is owned by an owner 202, and FIG. 2 illustrates how the electronic coin 200 is defined by the digital signatures of the previous owners 204, 206, and 208. Specifically, in transaction A, a hash of the public key of owner 206 (i.e., the owner receiving, as a result of transaction A, an electronic coin 200₁ defined by digital signatures provided up to transaction A) and the previous transaction (not illustrated, but occurring prior to transaction A) was signed by owner 208 (i.e., the owner providing, as a result of transaction A, the electronic coin 200₁ defined by digital signatures provided up to transaction A) and added to an initial electronic coin (which was defined by digital signatures provided up to the transaction prior to transaction A) such that the electronic coin 200₁ was transferred to owner 206. Similarly, in transaction B, a hash of the public key of owner 204 (i.e., the owner receiving, as a result of transaction B, an electronic coin 200₂ defined by digital signatures provided up to transaction B) and transaction A was signed by owner 206 and added to the electronic coin 200₁ such that the electronic coin 200₂ was transferred to owner 204. Similarly, in transaction C, a hash of the public key of owner 202 (i.e., the owner receiving, as a result of transaction C, the electronic coin 200 defined by digital signatures provided up to transaction C) and the transaction B was signed by owner 204 and added to the electronic coin 200₂ such that the electronic coin 200 was transferred to owner 202. As is understood in the art, any payee receiving an electronic coin (e.g., owner 206 in transaction A, owner 204 in transaction B, and owner 202 in transaction C) can verify the signatures to verify the chain of ownership of the electronic coin. In the discussion below, it should be understood that the term “electronic coins” is used to encompass any amount of electronic coins, from fractions of a coin (e.g., 0.00564500 electronic coins) to many multiples of coins (e.g., 56,000.00000000 electronic coins).

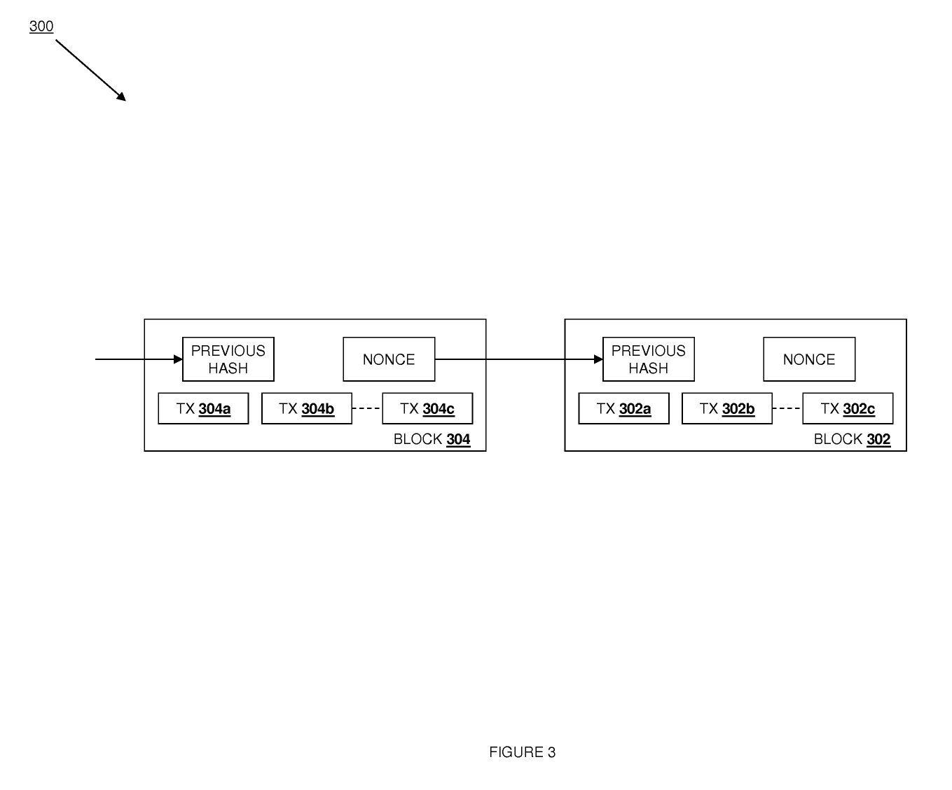

Referring now to FIG. 3, an embodiment of a crypto currency public ledger 300 is illustrated and described briefly for reference to the method 100 discussed below. The crypto currency public ledger 300 operates to verify that payers transferring an electronic coin (e.g., referring back to FIG. 2, owner 206 in transaction A, owner 204 in transaction B, and owner 202 in transaction C) did not “double-spend” (e.g., sign any previous transactions involving) that electronic coin. To produce the crypto currency public ledger 300, a distributed network of devices operates to agree on a single history of transactions in the order in which they were received such that it may be determined that a transaction between a payer and a payee using an electronic coin is the first transaction associated with that electronic coin. Each device in the distributed network operates collect new transactions into a block, and then to increment a proof-of work system that includes determining a value that when hashed with the block provides a required number of zero bits. For example, for a block 302 that includes a plurality of transactions 302a, 302b, and up to 302c, a device in the distributed network may increment a nonce in the block 302 until a value is found that gives a hash of the block 302 the required number of zero bits. The device may then “chain” the block 302 to the previous block 304 (which may have been “chained” to a previous block, not illustrated, in the same manner). When devices in the distributed network find the proof-of-work for a block, that block (e.g., block 302) is broadcast to the distributed network, and other devices in the distributed network will accept that block if all the transactions in it are valid and not already spent (which may be determined by creating the next block using the hash of the accepted block 302). The distributed network will always consider the longest chain of blocks to be the correct one, and will operate to continue to extend it. If a device receives two different versions of a block, it will work on the first block received, but save the second block received in case the branch of the chain that includes the second block becomes longer (at which point that device with switch to working on the branch of the chain that includes the second block).

In the manner described above, a distributed crypto currency system is provided in which payers and payees may participate in transactions with each other using the electronic coins discussed above and without the need for a centralized authority such as a bank. Each of those transactions is recorded in the crypto currency public ledger to ensure that the electronic coins may only be spent by a payer once. However, as described above, the transactions in such distributed crypto currency systems are not reversible without cooperation of a payee and, as such, allow for users of the crypto currency system who gain access to the electronic coins of another user to transfer those electronic coins to themselves with little to no repercussions. The method 100 contemplates improvements on such distributed crypto currency systems that provides for incentives against such activities by reducing and/or eliminating the value of electronic coins that are transferred from a user without their authorization.

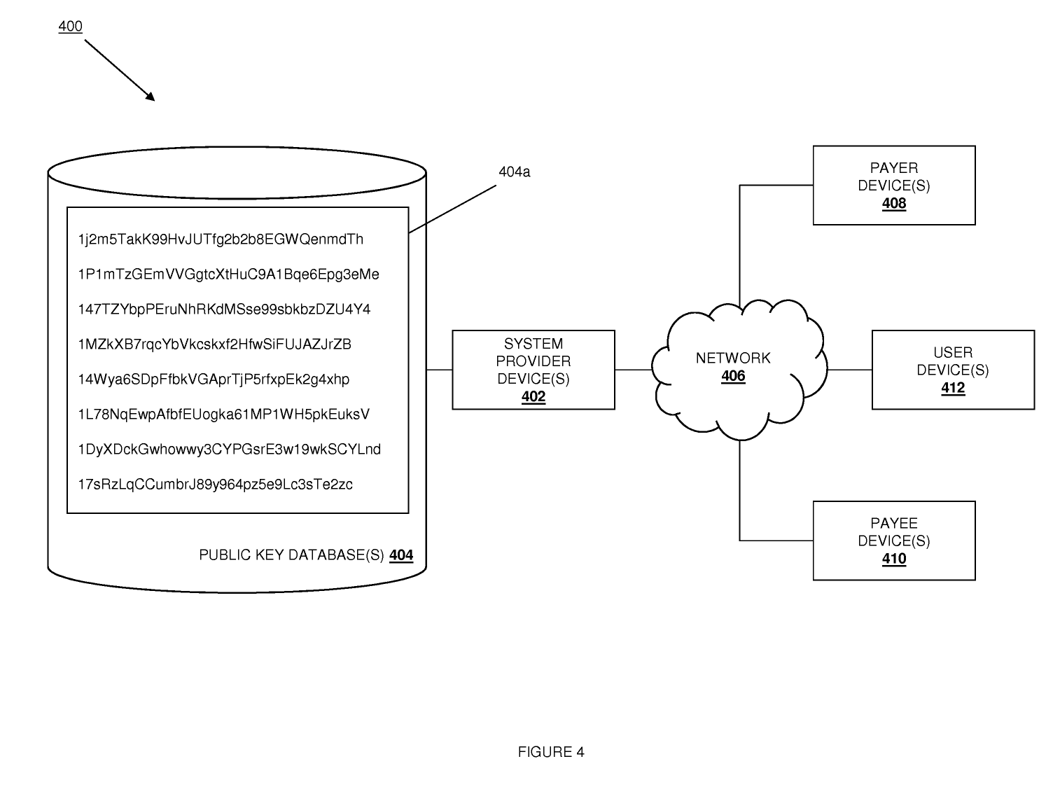

Referring now to FIGS. 1 and 4, the method 100 begins at block 102 where an unauthorized crypto currency transfer report is received from a user. FIG. 4 illustrates a distributed crypto currency system 400 that includes one or more system provider device(s) 402 that are coupled to public key database(s) 404. In some embodiments, the system provider device(s) 402 may include one or more system provider devices that are connected to or otherwise have access to a public key database. In other embodiments, the system provider device(s) 402 may be a plurality of system provider devices that each includes an identical public key database that is shared with each of the system provider devices in the distributed crypto currency system 400 (discussed in further detail below). The system provider device(s) 402 are couple through a network 404 (e.g., the Internet) to one or more payer devices 408, one or more payee devices 410, and one or more user devices 412. One of skill in the art in possession of the present disclosure will recognize that any owner of electronic coins in the distributed crypto currency system 400 may be a user of the distributed crypto currency system 400 (discussed below as experiencing an unauthorized transfer of their electronic coins), or a payer when transferring electronic coins to a payee in the distributed crypto currency system 400. Furthermore, any user in the distributed crypto currency system 400 may be a payee when being transferred electronic coins from an payer in the distributed crypto currency system 400. Any user, payer, or payee may include one of the devices 408, 410, or 412 respectively to send or receive the electronic coins and/or report unauthorized transactions as discussed below.

In an embodiment of block 102, the system provider device(s) 402 receive an unauthorized crypto currency transfer report from one of the user device(s) 12 over the network 406. As discussed above, users of the distributed crypto currency system 400 are subject to theft of their electronic coins due to unauthorized transfers of those electronic coins that can occur in a wide variety of manners. For example, a user device 412 of a user of the distributed crypto currency system 400 that is an owner of electronic coins may store an “electronic wallet” that includes the private key that allows that user to sign transactions such that those electronic coins may be transferred to other users of the distributed crypto currency system 400. In some examples of electronic coin theft, a first electronic wallet may be left unprotected on a first user device of a first user (e.g., unencrypted such that a user identifier and password do not need to be provided on the first user device to sign transactions using the first electronic wallet) such that a second user may gain access to the first electronic wallet on the first user device and sign a transaction involving their own public key (e.g., a public key associated with a second electronic wallet on a second user device of the second user), which results in the electronic coins associated with the first electronic wallet being “transferred to” (i.e., associated with) the second electronic wallet of the second user.

Furthermore, even protected electronic wallets are subject to theft based on password theft (e.g., guessing a user password, stealing a user password via a virus placed on the user device (e.g., a virus that installs a key logger on the user device), etc.), accessing an electronic wallet seed (i.e., a seed for a deterministic electronic wallet that allows for reproduction of a users private key), and/or otherwise gaining access to a private key of a user to transfer their electronic coins (i.e., associate their electronic coins) with another wallet (i.e., a public key generated by that electronic wallet) without their authorization.

In response to an unauthorized crypto currency transfer of electronic coins from their electronic wallet, a user may use their user device 412 to provide an unauthorized crypto currency transfer report over the network 406 to the system provider device(s) 402. For example, upon the occurrence of (or sometime following) an unauthorized crypto currency transfer (e.g., in response to a crypto currency transfer notification (e.g., an email), checking an electronic wallet, etc.), the user experiencing the unauthorized crypto currency transfer may send the details of the unauthorized crypto currency transfer over the network 406 to the system provider device(s) 402. In the illustrated embodiment, the public key database(s) 404 include a public key list 404a having a plurality of public keys that are associated with unauthorized crypto currency transfers (e.g., that were reported at block 102 in previous iterations of the method 100).

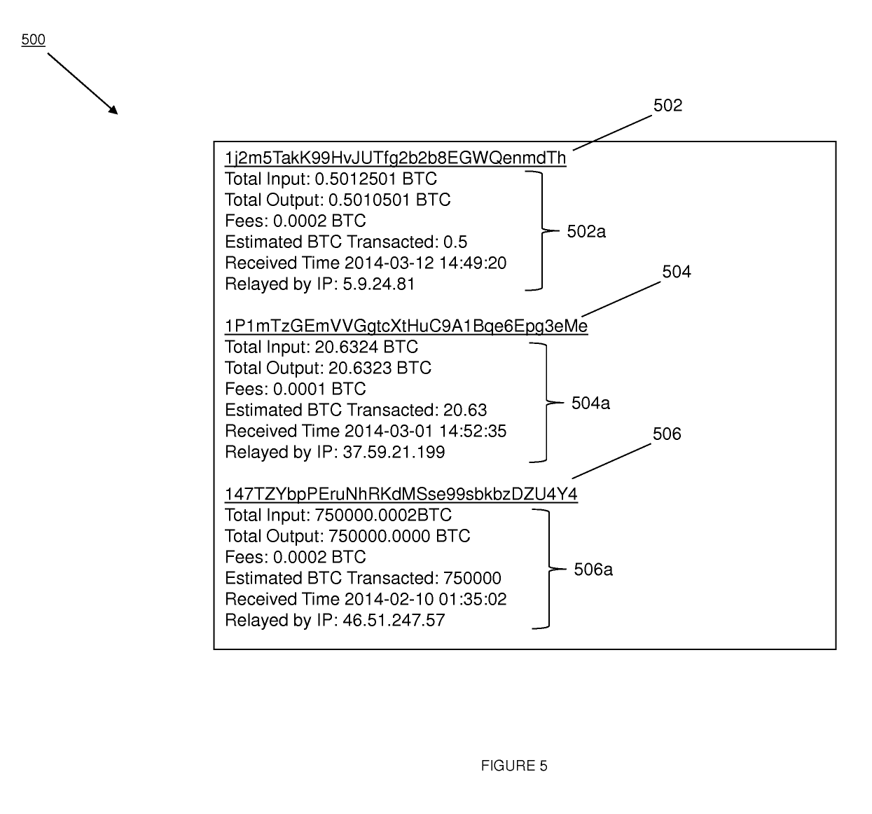

Referring to FIG. 5, an embodiment of a public key list 500, which may be the public key list 404a of FIG. 4, is illustrated that includes a plurality of public keys 502, 504, and 506. In the illustrated embodiment, each of the public keys 502, 504, and 506 are associated with unauthorized crypto currency transfer details 502a, 504a, and 506a, respectively, that may include any of the details of the unauthorized crypto currency transfer such as, for example, the amount of electronic coins transferred, the fees associated with the transfer, the date and time of the transfer, an Internet Protocol (IP) address associated with the electronic transfer, and/or any other information known in the art to be associated with a crypto currency transfer.

The method 100 then proceeds to block 104 where the unauthorized crypto currency transfer report is confirmed. In different embodiments of block 102, the system provider device(s) 402 may operate in a variety of ways to confirm the unauthorized crypto currency transfer report received at block 102. For example, the system provider device(s) 402 may provide a reporting tool or application such as, for example, a website, at which a user may use the user device 412 to provide the unauthorized crypto currency transfer report. The reporting tool or application may operate to confirm unauthorized crypto currency transfer reports that provide a plurality of requested information (e.g., the details of the unauthorized crypto currency transfer discussed above), that provide a confirmation of the identity of the user, that provide a police report of the unauthorized crypto currency transfer, and/or that provide a plurality of other confirmation information known in the art.

In an embodiment, there may be a maximum amount of time (e.g., as measured from the date and time of the unauthorized crypto currency transfer) that may pass before an unauthorized crypto currency transfer report will not be confirmed at block 104. For example, users may be required to report unauthorized crypto currency transfers within 1 hour of their transfer date in order for such unauthorized crypto currency transfer reports to be confirmed. However, in other embodiments (or as part of similar embodiments), the system provider device(s) 402 may wait a predetermined time period (e.g., a time period necessary for a predetermined number of confirmations from the distributed network) subsequent to receiving an unauthorized crypto currency transfer report before confirming that unauthorized crypto currency transfer report (and subsequently storing its associated public key, discussed below).

For example, the system provider device(s) may operate to contact a user associated with the public key that is part of an unauthorized crypto currency transfer report in order to confirm the unauthorized crypto currency transfer report. In some embodiments, users may register themselves (e.g., via a user name or other identifier) and public keys that they use to receive electronic coins with the system provider device(s) 402, and at block 104, a public key that is associated with an unauthorized crypto currency transfer report and that is also registered with the system provider device(s) 402 may allow the system provider device(s) 402 to contact the registered user to inform that registered user of the unauthorized crypto currency transfer report that includes one of their public keys. In such situations, the registered user associated with a public key in a unauthorized crypto currency transfer report may respond to the unauthorized crypto currency transfer report such that a dispute between the registered user and the reporting user may be mediated by the system provider device(s) 402 in confirming the unauthorized crypto currency transfer report, while a registered user (or a public key that is registered) that does not respond in the predetermined amount of time may result in the unauthorized crypto currency transfer report being confirmed.

In other embodiments, any public key associated with an unauthorized crypto currency transfer report may be made publicly available in a searchable database such that users of the distributed crypto currency system may determine whether their public keys have been provided in unauthorized crypto currency transfer reports. While a few examples have been provided, any of a variety of systems and methods may be instituted to determine how and when an unauthorized crypto currency transfer report should be confirmed or not.

The method 100 then proceeds to block 106 where the public key associated with the unauthorized crypto currency transfer report is stored in a database. In an embodiment, in response to confirming the unauthorized crypto currency transfer report at block 104, the system provider device(s) 402 may store the public key associated with the unauthorized crypto currency transfer report in the public key database 404. As such, any of the public keys (e.g., the public keys 502, 504, and 506) and associated unauthorized crypto currency transfer details in the public key lists 404a or 500 may have been stored in the public key database 404 in the manner discussed above. In some embodiments, identifiers for the public keys (or the positions of the public keys in the crypto currency public ledger) may be stored in the public key database 404 rather than the actual public keys. Furthermore, the public keys (or identifiers) stored in the public key database 404 may be forwarded to other system provider devices 402 following receipt of their unauthorized crypto currency transfer reports, following the confirmation of such reports, etc., such that the public key database 404 is distributed throughout the distributed network.

As discussed in further detail below, by compiling public keys that are associated with unauthorized crypto currency transfers in the public key database(s) 404, a public key “blacklist” is created that includes public keys that have been used in the unauthorized transfer of electronic coins. The public key “blacklist” may allow for the position of unauthorized transactions (e.g., electronic coin thefts) in the crypto currency public ledger to be determined, and allows for the distributed crypto currency system to track the further use of those electronic coins in subsequent transactions. As such, a subsequent transaction using electronic coins that are associated with a public key that is stored in the public key database(s) 404 may be tracked. For example, a first public key may be stored in the public key database(s) 404 in response to a confirmed unauthorized crypto currency transfer report associated with an initial transaction of electronic coins, and a subsequent transaction may involve a second public key that transfers at least some of those electronic coins to another user. In such an example, that second public key may also be stored in the public key database(s) 404 based on the electronic coin transfer that includes electronic coins that were associated with the first public key that is stored in the public key database(s) 404. In some embodiments, the “blacklist” may have different levels for reported public keys that indicate whether those public keys are currently in dispute or have been determined to be part of an unauthorized transaction.

The method 100 then proceeds to decision block 108 where it is determined whether a current transaction inquiry has been received. As discussed in further detail below, a current transaction inquiry may be received by the system provider device(s) 402 from any payee receiving electronic coins from a payer. If at decision block 108 it is determined that no current transaction inquiry is received, the method 100 proceeds back to loop through blocks 102-106 of the method 100 such that public keys are stored in the public key database(s) 404 in response to receiving and confirming unauthorized crypto currency transfer reports. If at decision block 108, it is determined that a current transaction inquiry is received, the method 100 proceeds to block 110, discussed below.

In an embodiment, the system provider device(s) 402 may receive a current transaction inquiry over the network 406 from one of the payee devices 410. For example, any one of each of the payer devices 408 and payee devices 410 may initiate a current transaction. For example, a payer associated with the payer device 408 may wish to purchase one or more products from a payee associated with the payee device 410, and in response may attempt to transfer electronic coins to the payee as discussed above with reference to FIG. 2. However, other forms of transactions are envisioned as falling within the scope of the present disclosure. Prior to, or in response to the initiation of, such a current transaction, the payee may use the payee device 410 to send a current transaction inquiry over the network 406 to the system provider device(s) 402, and that current transaction inquiry may include the public key of the payer that was used in transferring the electronic coins (which are being used by the payer in the current transaction) to the payer in the previous transaction. In some embodiments, that public key may be provided by the payer to the payee prior to the transfer of the electronic coins from the payer to the payee. In other embodiments, that public key may be provided by the payer to the payee as part of the transfer of the electronic coin from the payer to the payee (i.e., the payee may actually receive the electronic coins from the payer prior to determining whether to proceed in the transaction, discussed in further detail below). In yet another embodiment, the transaction may be performed through a payment service provider (a system provider in this example) such that the payer transfers the electronic coins to the payment service provider, who will then transfer those electronic coins to the payee if the payer public key used in the previous transaction(s) with the electronic coins is not associated with a public key in the public key database 404, discussed in further detail below.

At block 110, a payer public key that is associated with the current transaction between the payer and the payee is determined. As discussed above, an electronic coin owned by the payer will have a public key of the payer associated with it (e.g., the electronic coin 200 of FIG. 2 that is owned by the owner 202 is associated with a public key of the owner 202), and the crypto currency public ledge 300 will also detail the public key used by the payer to obtain those electronic coins. At block 110, the system provider device(s) 402 determine the payer public key that is associated with the electronic coins that are being transferred to the payee in the current transaction by, for example, receiving the payer public key from the payee, referencing the crypto currency public ledger to determine the payer public key, retrieving the payer public key from the electronic coins that have been transferred to the system provider device(s) 402 by the payer (e.g., for transfer to the payee), and/or using a variety of other methods known in the art. As such, following block 110, the system provider device(s) 402 have the payer public key that was used by the payer in a previous transaction to receive the electronic coins that are being used in the current transaction with the payee.

The method 100 then proceeds to decision block 112 where it is determined whether the payer public key is associated with previous transaction public keys in the database. In an embodiment, for any performance of the method 100, the public keys that are stored in the public key database 404 may be referred to as previous transaction public keys relative to a payer public key that is being used in a current transaction (e.g., for which the current transaction inquiry was received at decision block 108). Thus, at decision block 112, the system provider device(s) 402 use the payer public key determined at block 110 of the method 100 to reference the public key database 404 and determine whether that payer public key is associated with one of the previous transaction public keys in the public key database.

In an embodiment of decision block 112, the system provider device(s) 402 may determine whether the payer public key is associated with the previous transaction public keys in the public key database 404 by determining whether the payer public key is the same as one of the previous transaction public keys that are stored in the public key database 404. For example, the system provider device may determine whether the payer public key being used in the current transaction is one of the previous transaction public keys in the public key database 404 (i.e., whether that payer public key was included in a previously received and confirmed unauthorized transaction report such that it was added to the public key database 404). In another example, the system provider device(s) 402 may determine whether the payer public key being used in the current transaction was previously added to the public key database 404 in response to determining that it was involved in a transfer with one of the previous transaction public keys in the public key database 404 (i.e., that payer public key was not part of an unauthorized crypto currency transfer report, but rather was involved in a transfer with a previous transaction public key that was part of an unauthorized crypto currency transfer report).

In another embodiment of decision block 112, the system provider device(s) 402 may determine whether the payer public key is associated with the previous transaction public keys in the public key database 404 by determining whether the payer public key was involved in a transaction with one of the previous transaction public keys that are stored in the public key database 404. For example, the system provider device(s) 402 may determine (e.g., using the crypto currency ledger) whether the payer public key (which is not currently included in the public key database 404) was involved with a previous transaction public key that is stored in the public key database 404 (e.g., subsequent to receiving an unauthorized crypto currency transfer report for that previous transaction public key based on a previous transaction, but without determining any association between the payer public key and that previous transaction public key between that previous transaction and the current transaction).

In some embodiments, a network of payees may agree to not accept electronic coins associated with a payer public key if that payer public key was used to receive electronic coins from a previous transaction public key (which is stored in the public key database 404 based on a confirmed unauthorized crypto currency transfer report) over a minimum amount of time following the adding of that previous transaction public key to the public key database 404. As such, payees and system providers may agree on the minimum time interval following the adding of a public key to the blacklist of public keys after which electronic coins having any association with that public key will not be accepted by the payees.

If, at decision block 112, the system provider device(s) determine that the payer public key is not associated with a previous transaction public key in the public key database 404, the method 100 proceeds to block 114 where a message is sent to proceed with the current transaction. A determination that a payer public key is not associated with a previous transaction public key in the public key database 404 informs the system provider device(s) 402 that the payer involved in the current transaction has obtained the electronic coins legitimately (e.g., through authorized crypto currency transfer from the previous owner). Furthermore, in embodiments where any previous transaction associated with the electronic coins are checked to ensure no previous transaction public keys associated with the electronic coin have been stored in the public key database 404, the determination that a payer public key is not associated with a previous transaction public key in the public key database 404 informs the system provider device(s) that the electronic coins involved in the current transaction have never been involved in an unauthorized crypto currency transfer from any of its previous owners.

As such, in response to determining that the payer public key is not associated with the previous transaction public keys in the public key database 404, the system provider device(s) 402 may send a message to the payer device 410 over the network 406 that informs the payer that they should proceed with the current transaction. Messages sent at block 114 may include emails, texts, application specific messages, and/or any other notification known in the art that would inform the payee that they should proceed with the transaction. In some embodiments, the system provider device(s) may act as an intermediary between the payer and the payee to receive and hold the electronic coins received from the payer prior to transferring them to the payee. In such embodiments, at block 114, the message sent to proceed in the current transaction may actually include the electronic coins that the system provider device(s) 402 received from the payer and is transferring to the payee. As such, only current transactions that include a payer public key (or payer public keys) that are not included in the public key database 404 may be participated in by payees that are part of the distributed crypto currency system 400.

If, at decision block 112, the system provider device(s) determine that the payer public key is associated with a previous transaction public key in the public key database 404, the method 100 proceeds to block 116 where a message is sent to not proceed with the current transaction. A determination that a payer public key is associated with a previous transaction public key in the public key database 404 informs the system provider device(s) 402 that the payer involved in the current transaction has obtained the electronic coins illegitimately (e.g., through an unauthorized crypto currency transfer from the previous owner). Furthermore, in embodiments where any previous transaction associated with the electronic coins are checked to determine whether previous transaction public keys associated with the electronic coin have been stored in the public key database 404, the determination that a payer public key is associated with a previous transaction public key in the public key database 404 informs the system provider device(s) that the electronic coins involved in the current transaction were at some time in the past involved in an unauthorized crypto currency transfer from at least one of its previous owners.

As such, in response to determining that the payer public key is associated with the previous transaction public keys in the public key database 404, the system provider device(s) 402 may send a message to the payer device 410 over the network 406 that informs the payer that they should not proceed with the current transaction. Messages sent at block 114 may include emails, texts, application specific messages, and/or any other notification known in the art that would inform the payee that they should not proceed with the transaction. In some embodiments, the system provider device(s) may act as an intermediary between the payer and the payee to receive and hold the electronic coins received from the payer prior to transferring them to the payee. In such embodiments, at block 114, the message sent to not proceed in the current transaction may include a message that the electronic coins are being held by the system provider device(s) or being returned to the payer because they have been involved in an unauthorized crypto currency transfer. As such, current transactions that include a payer public key (or payer public keys) that are included in the public key database 404 will be not be participated in by payees that are part of the distributed crypto currency system 400.

The method 100 may then proceed to optional block 118 where communication between the payer and a reporting user is facilitated. In an embodiment, the system provider device(s) 402 may operate to facilitate communication between the payer (who is associated with the payer public key that is associated with a previous transaction public key in the public key database 404) and the reporting user that provided the unauthorized crypto currency transfer report at block 106 that included the previous transaction public key that is associated with the payer public key. In some embodiments, the system provider device(s) 402 may provide a mediation authority for electronic coins that are associated with unauthorized crypto currency transfers to allow arbitration of disputes over electronic coins and all users of those electronic coins to “rehabilitate” electronic coins that have been associated with unauthorized crypto currency transfers. As discussed above, in embodiments where the system provider device(s) 402 are used to hold the electronic coins that are part of the transaction between the payer and the payee, the system provider device(s) 402 may either return the electronic coins to the payer or hold those electronic coins as part of a rehabilitation process to return those electronic coins (or a portion of those electronic coins) to the previous owner that reported their unauthorized transfer.

For example, a payee may require a payer to transfer electronic coins to be used in a current transaction with the payee to the system provider device(s) 402 such the system provider actually owns those coins, and can transfer those electronic coins to the payee in the event the method proceeds to block 114. However, in such embodiments in which the method proceeds to block 116, at block 118 the system provider device(s) may hold those electronic coins and institute block 118 as an arbitration system in which the system provider device(s) 402 act to determine the rightful owner of those electronic coins. Furthermore, in the situations where the payer public key is not included in the public key database 404 but rather is associated with a previous transaction public key that is included in the public key database 404, the system provider device(s) 404 may institute some equitable division of the electronic coins between that payer and the user that provided the unauthorized crypto currency transfer report associated with those electronic coins. For example, the system provider device(s) 402 may facilitate a crypto currency transfer between the payer and the reporting user (or from the system provider device to the reporting user) such that the payer transfers some reduced percentage of a crypto currency transfer that was associated with the previous transaction that resulted in the reporting user providing the unauthorized crypto currency transfer report. As such, electronic coins may be “rehabilitated” and any public key associated with rehabilitated electronic coins may be removed from the public key database 404.

Thus, systems and methods for providing a distributed crypto currency system have been described that provide for the collection of public keys that are associated with unauthorized crypto currency transactions, and the monitoring of current transactions for those or related public keys to determine if a payer is attempting to spend an electronic coin that has been stolen from a prior user. By preventing (or advising payees to refrain from) transactions involving such electronic coins, the systems and methods described herein reduce the incentives to steal electronic coins by reducing their value through the reduction of the ability to use such electronic coins. Furthermore, any public key used to receive stolen electronic coins will be associated with those stolen electronic coins and, as such, will taint any prior crypto currency associated with that public key. A network of payees agreeing to participate in the systems and methods of the present disclosure provides for a level of additional security in distributed crypto currency systems by reducing the ability to spend electronic coins obtained by illegitimate means and providing for the rehabilitation of those electronic coins by returning as least some portion of those electronic coins to their legitimate owners if they are found.

Furthermore, the systems and methods of the present disclosure may operate to disincentive the use of current methods for hiding the theft of crypto currencies. For example, crypto currencies “tumblers” are sometimes used for electronic coins associated with unauthorized crypto currency transfers in order to “launder” those electronic coins. Crypto currency tumblers operate by transferring the electronic coins from an owner first public key associated with an owner of stolen electronic coins to a tumbler public key associated with the tumbler provider. The tumbler provider then transfers electronic coins, in the same amount as were transferred from the owner first public key to the tumbler public key, from one or more other user public keys to an owner second public key of the owner. As such, the owner receives electronic coins in an amount that is the same as the stolen electronic coins, but now associated with a “clean” public key. To further launder the stolen electronic coins, the tumbler provider may time delay the electronic coin transfer to the owner second public key, and may also have the owner withdraw the electronic coins in different amounts over time. Over time, the tumbler provider will transfer electronic coins associated with the tumbler public key (i.e., that received the stolen electronic coins from the owner first public key) to other user public keys performing the same function as described above. However, the systems and methods of the present disclosure make it much more dangerous to use or run a tumbler, as the possibility of receiving electronic coins (or any portion of an electronic coin) that are associated with a public key that has been stored in the public key database 404 will always be present, operating to possibly taint any electronic coins received and transferred from the tumbler.

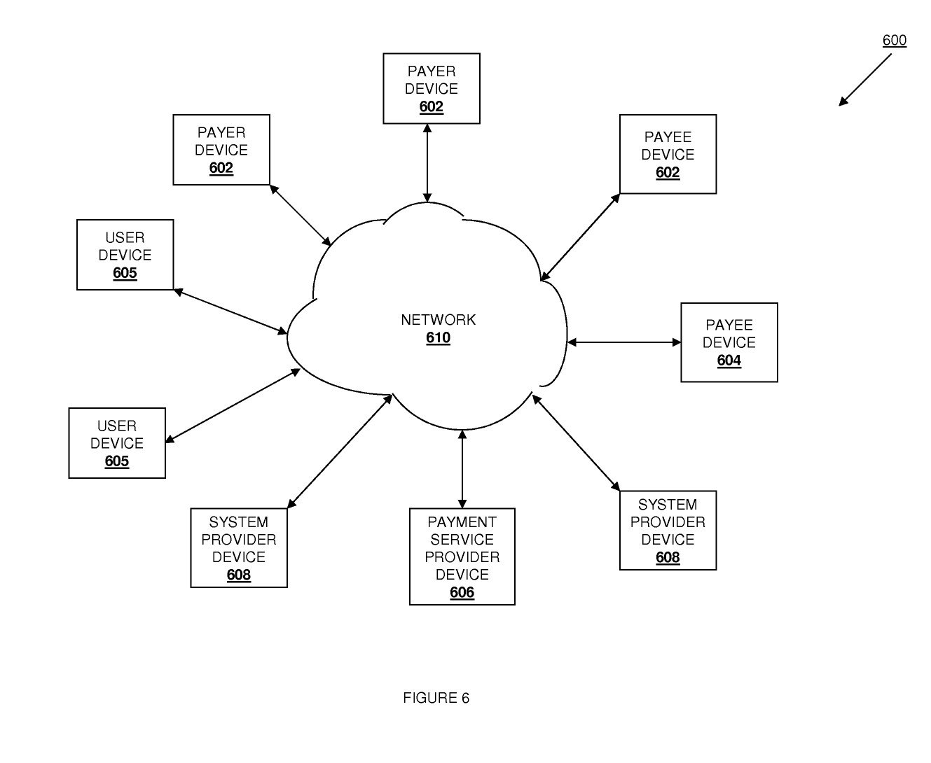

Referring now to FIG. 6, an embodiment of a networked system 600 used in the distributed crypto currency system described above is illustrated. The networked system 600 includes a plurality of payer devices 602, a plurality of payee device 604, a plurality of user devices 605, a payment service provider device 606, and/or a plurality of system provider devices 608 in communication over a network 610. Any of the payer devices 602 may be the payer devices that are operated by the payers, discussed above. Any of the payee devices 604 may be the payee devices that are operated by the payees, discussed above. Any of the user devices 605 may be the user devices that are operated by the users, discussed above. The payment service provider device 606 may be the payment service provider devices discussed above and may be operated by a payment service provider such as, for example, PayPal Inc. of San Jose, Calif. The system provider devices 608 may be the system provider devices operated by the system providers, discussed above.

The payer devices, payee devices, user devices, payment service provider device, and/or system provider device may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The payer devices 602 may be implemented using any appropriate combination of hardware and/or software configured for wired and/or wireless communication over network 610. For example, in one embodiment, the payer devices 602 may be implemented as a personal computer of a user in communication with the Internet. In other embodiments, the payer devices 602 may be a smart phone, laptop computer, wearable computing device, and/or other types of computing devices.

The payer devices 602 may include one or more browser applications which may be used, for example, to provide a convenient interface to permit the payers to browse information available over the network 610. For example, in one embodiment, the browser application may be implemented as a web browser configured to view information available over the Internet.

The payer devices 602 may also include one or more toolbar applications which may be used, for example, to provide user-side processing for performing desired tasks in response to operations selected by the payer. In one embodiment, the toolbar application may display a user interface in connection with the browser application.

The payer devices 602 may further include other applications as may be desired in particular embodiments to provide desired features to the payer devices 602. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 610, or other types of applications. Email and/or text applications may also be included, which allow the payer to send and receive emails and/or text messages through the network 610. The payer devices 602 include one or more user and/or device identifiers which may be implemented, for example, as operating system registry entries, cookies associated with the browser application, identifiers associated with hardware of the payer devices 602, or other appropriate identifiers, such as a phone number. In one embodiment, the user identifier may be used by the payee devices 604, the payment service provider device 606, and/or the system provider devices 608 to associate the payer with a particular account as further described herein.

The payee devices 604 may be maintained, for example, by a conventional or on-line merchant, conventional or digital goods seller, individual seller, and/or application developer offering various products and/or services in exchange for payment to be received conventionally or over the network 610. In this regard, the payee devices 604 may include a database identifying available products and/or services (e.g., collectively referred to as items) which may be made available for viewing and purchase by the payee.

The payee devices 604 also may include a checkout application which may be configured to facilitate the purchase by the payer of items. The checkout application may be configured to accept payment information from the payer through the payer device 602 and/or from the payment service provider through the payment service provider device 606 over the network 610.

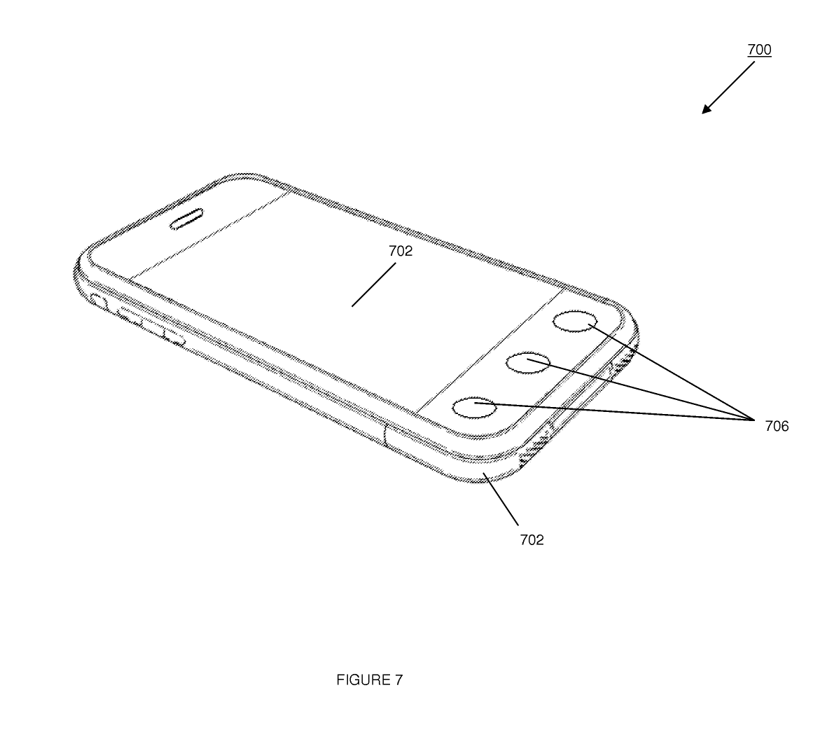

Referring now to FIG. 7, an embodiment of a payer device, payee device, and/or user device 700 is illustrated. The device 700 may be the payer devices, payee devices, and/or user devices discussed above. The device 700 includes a chassis 702 having a display 704 and an input device including the display 704 and a plurality of input buttons 706. One of skill in the art will recognize that the device 700 is a portable or mobile phone including a touch screen input device and a plurality of input buttons that allow the functionality discussed above with reference to the method 100. However, a variety of other portable/mobile devices and/or desktop devices may be used in the method 100 without departing from the scope of the present disclosure.

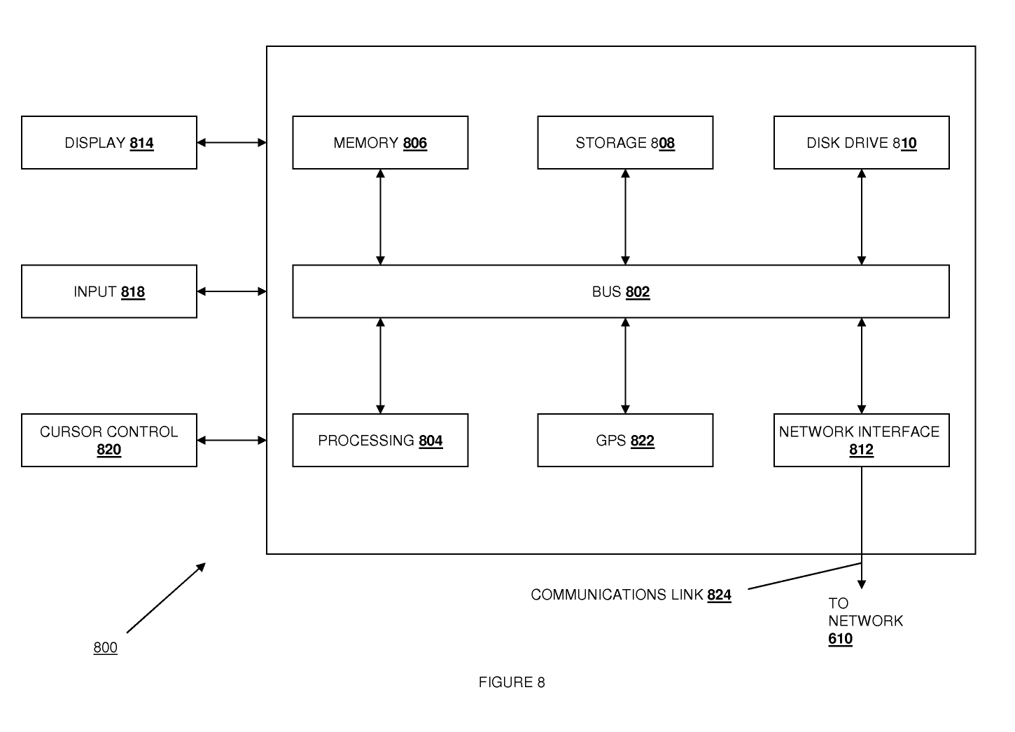

Referring now to FIG. 8, an embodiment of a computer system 800 suitable for implementing, for example, the payer devices, payee devices, user devices, payment service provider device, and/or system provider devices is illustrated. It should be appreciated that other devices utilized by payers, payees, users, payment service providers, system providers, and third parties in the distributed crypto currency system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art). In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the payer devices, payee devices, user devices, payment service provider device, and/or system provider devices. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

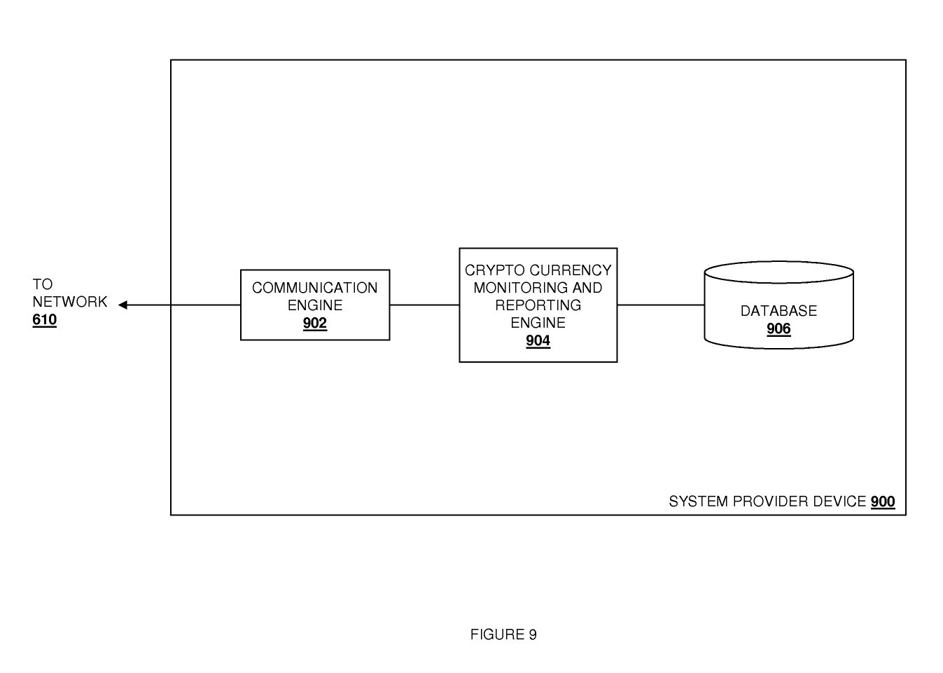

Referring now to FIG. 9, an embodiment of a system provider device 900 is illustrated. In an embodiment, the system provider device 900 may include the payment service provider device and/or system provider devices discussed above. The device 900 includes a communication engine 902 that is coupled to the network 610 and to a crypto currency monitoring and reporting engine 904 that is coupled to a database 906. The communication engine 902 may be software or instructions stored on a computer-readable medium that allows the device 900 to send and receive information over the network 610. The crypto currency monitoring and reporting engine 904 may be software or instructions stored on a computer-readable medium that is operable to receive unauthorized crypto currency transfer reports, confirm unauthorized crypto currency transfer reports, store public keys associated with unauthorized crypto currency transfer reports in the database 906, determine whether current transaction inquiries are received, determine payer public keys associated with a current transaction, determine whether payer public keys are associate with previous transaction public keys in the database 906, send messages to payees to proceed or not to proceed, facilitate communication between payers and reporting users, and/or provide any of the other functionality that is discussed above. While the database 906 has been illustrated as a single database that is located in the system provider device 900, one of skill in the art will recognize that it may include more than one database and may be connected to the crypto currency monitoring and reporting engine 904 through the network 610 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payers and payees; however, a payer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A distributed crypto currency system, comprising:
a non-transitory memory storing a plurality of previous transaction public keys that are each associated with a respective unauthorized crypto currency transfer as a result of a previous transaction;
one or more hardware processors coupled to the memory and operable to read instructions from the memory to perform the steps of:
receiving a payer public key that is associated with a current transaction between a payer and a payee;
determining whether the payer public key is included in the plurality of previous transaction public keys; and
in response to determining that the payer public key is included in the plurality of previous transaction public keys, sending a message to the payee to not proceed with the current transaction.

2. The system of claim 1, wherein the one or more hardware processors are operable to read instructions from the memory to perform the steps of:
in response to determining that the payer public key is not included in the plurality of previous transaction public keys, sending a message to the payee to proceed with the current transaction.

3. The system of claim 1, wherein the one or more processors are operable to read instructions from the memory to perform the steps of:
storing each of the plurality of previous transaction public keys in the non-transitory memory in response to receiving a respective unauthorized crypto currency transfer report for each respective previous transaction.

4. The system of claim 3, wherein each of the plurality of previous transaction public keys are stored in the non-transitory memory following a predetermined time period subsequent to the receiving of the respective unauthorized crypto currency transfer report for each respective previous transaction.

5. The system of claim 3, wherein the one or more hardware processors are operable to read instructions from the memory to perform the steps of:
forwarding each of the plurality of previous transaction public keys to at least one other system provider in response to receiving a respective unauthorized crypto currency transfer report for each respective transaction.

6. The system of claim 1, wherein the one or more hardware processors are operable to read instructions from the memory to perform the steps of:
determining whether the payer public key is associated with one of the plurality of previous transaction public keys by determining, using a crypto currency public ledger, whether the payer public key was involved in a transaction with one of the plurality of previous transaction public keys subsequent to receiving an unauthorized crypto currency transfer report for the one of the plurality of previous transaction public keys;
in response to determining that the payer public key is associated with one of the plurality of previous transaction public keys, sending a message to the payee to not proceed with the current transaction; and
in response to determining that the payer public key is associated with one of the plurality of previous transaction public keys, sending a message to the payee to proceed with the current transaction.

7. A method for providing a distributed crypto currency system, comprising:
receiving, by a system provider device from a payee device over a network, a payer public key that is associated with a current transaction between a payer and a payee;
determining, by the system provider device, whether the payer public key is included in a plurality of previous transaction public keys that are stored in a database and that are that are each associated with a respective unauthorized crypto currency transfer as a result of a previous transaction; and
in response to determining that the payer public key is included in the plurality of previous transaction public keys, sending, by the system provider device to the payee device over the network, a message to the payee to not proceed with the current transaction.

8. The method of claim 7, further comprising:
in response to determining that the payer public key is not included in the plurality of previous transaction public keys, sending, by the system provider device to the payee device over the network, a message to the payee to proceed with the current transaction.

9. The method of claim 8, further comprising:
storing at least one of the plurality of previous transaction public keys in the database in response to receiving, by the system provider device over the network, an unauthorized crypto currency transfer report for the respective previous transaction for the at least one of the plurality of previous transaction public key.

10. The method of claim 9, wherein the at least one of the plurality of previous transaction public keys are stored in the database following a minimum time period subsequent to the respective previous transaction for the at least one of the plurality of previous transaction public key.

11. The method of claim 9, further comprising:
forwarding, by the system provider device over the network to a plurality of other system provider devices, the at least one of the plurality of previous transaction public keys in response to receiving the respective unauthorized crypto currency transfer report for the respective previous transaction for the at least one of the plurality of previous transaction public key.

12. The method of claim 7, further comprising:
determining, by the system provider device, whether the payer public key is associated with one of the plurality of previous transaction public keys by determining, using a crypto currency public ledger, whether the payer public key was involved in a transaction with one of the plurality of previous transaction public keys subsequent to receiving an unauthorized crypto currency transfer report for the one of the plurality of previous transaction public keys;
in response to determining that the payer public key is associated with one of the plurality of previous transaction public keys, sending, by the system provider device to the payee device over the network, a message to the payee to not proceed with the current transaction; and
in response to determining that the payer public key is associated with one of the plurality of previous transaction public keys, sending, by the system provider device to the payee device over the network, a message to the payee to proceed with the current transaction.

13. The method of claim 7, further comprising:
facilitating, by the system provider device, a crypto currency transfer between the payer and a user that provided an unauthorized crypto currency transfer report that is associated with the payer public key.

14. A non-transitory computer-readable medium comprising instructions which, in response to execution by a computer system, cause the computer system to perform a method comprising:
receiving a payer public key that is associated with a current transaction between a payer and a payee;
determining whether the payer public key is included in a plurality of previous transaction public keys that are each associated with a respective unauthorized crypto currency transfer as a result of a previous transaction; and
in response to determining that the payer public key is included in the plurality of previous transaction public keys, sending a message to the payee to not proceed with the current transaction.

15. The non-transitory machine-readable medium of claim 14, wherein the method further comprises:
in response to determining that the payer public key is not included in the plurality of previous transaction public keys, sending a message to the payee to proceed with the current transaction.

16. The non-transitory machine-readable medium of claim 15, wherein the method further comprises:
storing identifiers for each of the plurality of previous transaction public keys in the database in response to receiving a respective unauthorized crypto currency transfer report for each respective previous transaction.

17. The non-transitory machine-readable medium of claim 16, wherein the identifiers for each of the plurality of previous transaction public keys in the crypto currency ledger are stored in the database following a predetermined time period subsequent to the receiving of the respective unauthorized crypto currency transfer report for each respective previous transaction.

18. The non-transitory machine-readable medium of claim 16, wherein the method further comprises:
forwarding each of the plurality of previous transaction public keys to at least one other system provider.

19. The non-transitory machine-readable medium of claim 14, wherein:
determining whether the payer public key is associated with one of the plurality of previous transaction public keys by determining, using a crypto currency public ledger, whether the payer public key was involved in a transaction with one of the plurality of previous transaction public keys subsequent to receiving an unauthorized crypto currency transfer report for the one of the plurality of previous transaction public keys;
in response to determining that the payer public key is associated with one of the plurality of previous transaction public keys, sending a message to the payee to not proceed with the current transaction; and
in response to determining that the payer public key is associated with one of the plurality of previous transaction public keys, sending a message to the payee to proceed with the current transaction.

20. The non-transitory machine-readable medium of claim 14, wherein the method further comprises:
facilitating a crypto currency transfer between the payer and a user that provided an unauthorized crypto currency transfer report for the current transaction public key, wherein the crypto currency transfer is a reduced percentage of a previous transaction crypto currency transfer associated with the unauthorized crypto currency transfer report.
